(19) United States
(12) Patent Application Publication
(10) Pub. No.: US 2017/0254370 A1
(43) Pub. Date: Sep. 7, 2017

(54) DUAL RATE OF RELEASE ON SELECTABLE CLUTCH PAWLS

(71) Applicant: BorgWarner Inc., Auburn Hills, MI (US)

(72) Inventors: Brett PEGLOWSKI, Oakland, MI (US); Michael W. CAMPBELL, Ortonville, MI (US)

(21) Appl. No.: 15/441,889

(22) Filed: Feb. 24, 2017

Related U.S. Application Data
(60) Provisional application No. 62/302,022, filed on Mar. 1, 2016.

(51) Int. Cl. F16D 23/12; F16D 41/12

(52) U.S. Cl. CPC F16D 23/12; F16D 41/12; F16D 2023/123

(57) ABSTRACT

The selectable clutch module may include a first member and a second member positioned adjacent to the first member. The selectable clutch module may further include a plurality of notches formed on the second member and an actuator operably coupled to an armature. Furthermore, the selectable clutch module may include a selectable locking mechanism including a first pawl and a second pawl, wherein the first and second pawls are configured to interact with the plurality of notches such that the selectable locking mechanism is selectively controlled between a plurality of locking modes. The selectable clutch module may further include a cam operatively associated with the armature and the cam may include a cam profile configured to engage with the first and second pawls. Moreover, the actuator may positon the cam profile to selectably actuate the selectable locking mechanism into one of the plurality of locking modes.

### CROSS-REFERENCE TO RELATED APPLICATION

This application is a non-provisional U.S. Application claiming priority under U.S. 35 U.S.C. §119(e) to U.S. Provisional Patent Application Ser. No. 62/302,022, filed on Mar. 1, 2016.

### FIELD OF DISCLOSURE

The present disclosure relates generally to clutches, and more particularly relates to selectable clutch modules.

### BACKGROUND OF DISCLOSURE

Some machines such as, automobiles, trucks, vans, agriculture equipment, construction equipment, and other such vehicles may be equipped with a selectable clutch module. In some selectable clutch module designs, engaged pawls may be required to release under torque. Typically, a cam may be actuated to engage a heel of the engaged pawl for release thereof. The geometry of the cam, however, commonly limits the force or requires a long stroke on the pawl.

### SUMMARY OF DISCLOSURE

In accordance with an aspect of the disclosure, a selectable clutch module is provided. The selectable clutch module may include a first member and a second member positioned adjacent to the first member and the second member being configured to rotate relative to the first member. The selectable clutch may further include a plurality of notches formed on the second member and an actuator may be operably coupled to an armature. Furthermore, a selective locking mechanism may include a first pawl rotatably coupled to the first member about a first pawl pivot point and a second pawl rotatably coupled to the first member about a second pawl pivot point, wherein each of the first and second pawls are configured to interact with the plurality of notches and the first and second pawls are rotatable between an open position and a locked position relative to the plurality of notches such that the selective locking mechanism is selectively controlled between a plurality of locking modes. The selectable clutch module may further include a cam operatively associated with the armature and the cam may include an engagement surface configured to engage with the first pawl and the second pawl. Furthermore, the actuator may actuate the armature such that the engagement surface of the cam is positioned relative to the first pawl and the second pawl to selectably actuate the selective locking mechanism into one of the plurality of locking modes.

In accordance with another embodiment of the present disclosure, a selectable clutch module is disclosed. The selectable clutch module may include a first member and a second member configured to rotate about a clutch module axis. The second member may be positioned adjacent to the first member and the second member may be configured to rotate relative to the first member. A plurality of notches may be formed on the second member and an actuator may be operably coupled to an armature. The selective clutch module may further include a selective locking mechanism including a first pawl rotatably coupled to the first member about a first pawl pivot point and a second pawl rotatably coupled to the first member about a second pawl pivot point, wherein each of the first and second pawls are configured to interact with the plurality of notches and the first and second pawls are rotatable between an open position and a locked position relative to the plurality of notches such that the selective locking mechanism is selectively controlled between a plurality of locking modes. Additionally the selectable clutch module may include a rotatable cam positioned in a radially exterior position to the second member and the selective locking mechanism. Moreover, the rotatable cam may be operatively associated with the armature such that an actuation of the actuator may cause the armature to impinge on the rotatable cam and rotate the rotatable cam about the clutch module axis. The selectable clutch module may further include an engagement surface formed on the rotatable cam and the engagement surface may be configured to selectively engage with the first pawl and the second pawl. Moreover, the actuation of the actuator may cause the rotatable cam to rotate such that the engagement surface of the rotatable cam is positioned relative to the first pawl and the second pawl to selectably actuate the selective locking mechanism into one of the plurality of locking modes.

These and other aspects and features of the present disclosure may be better appreciated by reference to the following detailed description and accompanying drawings.

### BRIEF DESCRIPTION OF DRAWINGS

FIG. 1a is an enlarged side view of a selectable clutch module illustrating an engaged position, with portions sectioned and broken away, in accordance with one possible embodiment of the present disclosure;

FIG. 1b is an enlarged side view of a selectable clutch module illustrating an engaged position, with portions sectioned and broken away in accordance with an alternative embodiment of the present disclosure;

FIG. 1c is an enlarged side view of a selectable clutch module illustrating an engaged position, with portions sectioned and broken away in accordance with another alternative embodiment of the present disclosure;

FIG. 2 is another enlarged side view of the selectable clutch module of FIG. 1a illustrating a high force, low lift ramp position or first open position, with portions sectioned and broken away, in accordance with one possible embodiment of the present disclosure;

FIG. 3 is another enlarged side view of the selectable clutch module of FIG. 1a illustrating a low force, high lift ramp position or second open position, with portions sectioned and broken away, in accordance with one possible embodiment of the present disclosure;

FIG. 4 is an end sectional view of a selectable clutch module constructed in accordance with the present disclosure;

FIG. 5 is an enlarged side view of one possible alternative embodiment of the selectable clutch module of FIG. 4 illustrating an engaged position, with portions sectioned and broken away, in accordance with the present disclosure;

FIG. 6 is another enlarged side view of the selectable clutch module of FIG. 4 illustrating a high force, low rise ramp position or first open position, with portions broken and sectioned away, in accordance with the present disclosure; and

FIG. 7 is another enlarged side view of the selectable clutch module of FIG. 4 illustrating a low force, high rise ramp position or second open position, with portions broken and sectioned away, in accordance with the present disclosure.

It should be understood that the drawings are not to scale, and that the disclosed embodiments are illustrated only diagrammatically and in partial views. It should also be understood that this disclosure is not limited to the particular embodiments illustrated herein.

### DETAILED DESCRIPTION

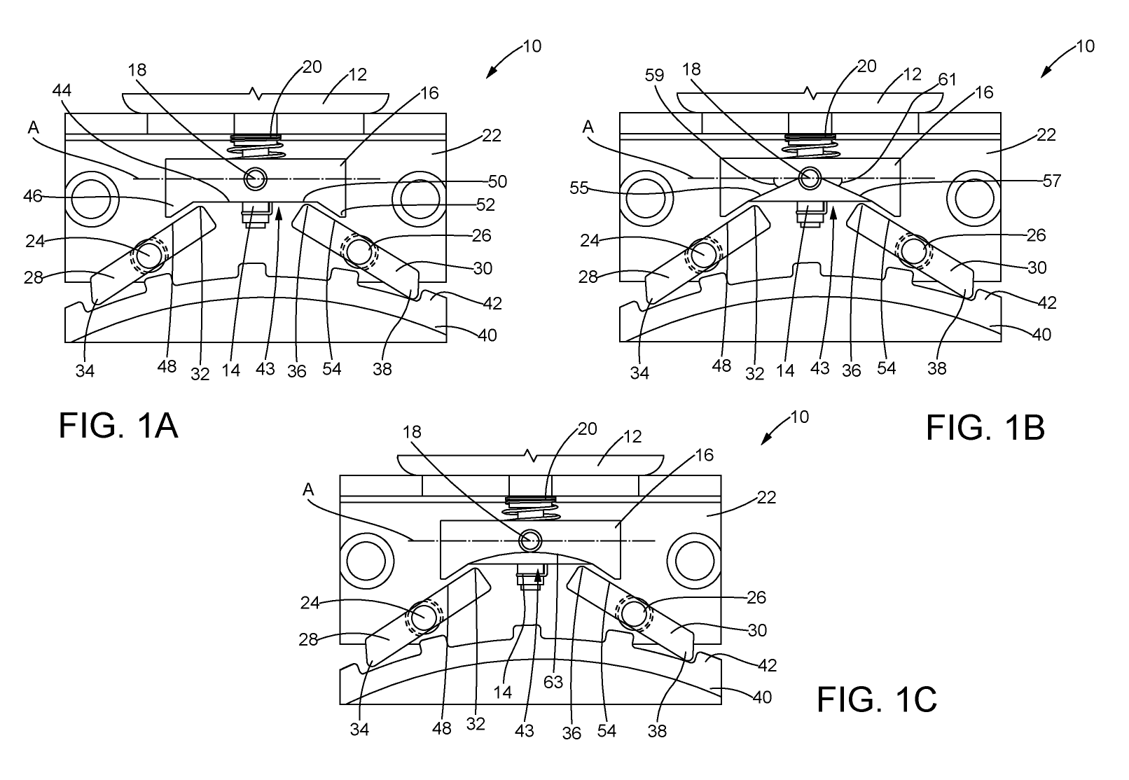

Referring now to FIGS. 1a-1c, several non-limiting examples of a selectable clutch module constructed in accordance with the present disclosure is generally referred to by reference numeral 10. The selectable clutch module 10 may be utilized in various machines such as, but not limited to, automobiles, trucks, vans, agriculture equipment, and construction equipment. The selectable clutch module 10 may include an actuator 12. The actuator 12 may include an armature 14. The armature 14 may be coupled to a cam 16 via pin 18. The actuator 12 may be a solenoid device, magnetic device, a servo motor, a hydraulic device, or other type of actuator. A biasing member 20 may be disposed around the armature 14 between the cam 16 and the actuator 12. The actuator 12 may be actuated to move the armature 14 and the cam 16.

The selectable clutch module 10 may include a first member 22. In some embodiments, the first member 22 may be configured as a non-rotating component of the selectable clutch module 10. Alternatively, in other embodiments the first member 22 may be configured as a rotatable component of the selectable clutch module 10 and the first member 22 may rotate in a clockwise direction, a counter clockwise direction, or both. Moreover, in some embodiments the first member 22 may be configured such that may be capable of operating in a first non-rotatable mode and a second rotatable mode. In one non-limiting example, the first member 22 may be configured with a selectable locking mechanism 23 that includes a first pawl 28 and a second pawl 30. Moreover, the first pawl 28 may be rotatably coupled to the first member 22 at a first pawl pivot point 24 and the second pawl 30 may be rotatably coupled to the first member 22 at a second pawl pivot point 26. As a result, the selectable locking mechanism 23 may be configured such that the first pawl 28 and the second pawl 30 are rotatable around the first pawl pivot point 24 and the second pawl pivot point 26, respectively. The first pawl 28 may include a first heel 32 and a first toe 34. Similarly, the second pawl 30 may include a second heel 36 and a second toe 38.

The selectable clutch module 10 may further include a second member 40 that may be rotatable with respect to the first member 22. Moreover, the second member 40 may be positioned adjacent to the first member 22, and the second member 40 may include a plurality of notches 42. In some embodiments, the plurality of notches 42 may be configured to interact with the first and second pawls 28, 30 that are rotatably coupled to the first member 22. The first and second pawls 28, 30 may rotate between open and locked positions. In the open positon, the second member 40 may rotate in a particular direction relative to the first member 22. In the locked or engaged position, the second member 40 may be prevented from rotating relative to the first member 22 due to interference between first and second pawls 28, 30 and the notches 42.

As further illustrated in FIGS. 1a-1c, the cam 16 may be configured with a cam profile 43 or other such engagement surface that engages, or otherwise, interacts with the first and second pawls 28, 30 such that the first and second pawls 28, 30 may rotate between open and locked positions. In one non-limiting example, the cam 16 illustrated in FIG. 1a may be configured with the cam profile 43 that includes a first engagement surface 44 and a first protuberance 46. The first engagement surface 44 may be engagable with the first heel 32 of the first pawl 28 and the first protuberance 46 may be engagable with a first portion 48 of the first pawl 28. The cam profile 43 may also include a second engagement surface 50 and a second protuberance 52. The second engagement surface 50 may be engagable with the second heel 36 of the second pawl 30 and the second protuberance 52 may be engagable with the second portion 54 of the second pawl 30. Furthermore, as illustrated in FIG. 1a the first and second protuberances 46, 52 may be positioned at opposing axial ends of the cam 16. However, the first and second protuberances 46, 52 may be placed at different positions along the cam 16 and the cam profile 43 in order to produce the desired interaction between the cam 16 and the first and second pawls 28, 30.

In a second non-limiting example, the cam profile 43 of the cam 16 illustrated in FIG. 1b may be alternatively configured with a first angled engagement surface 55 and a second engagement surface 57. The first angled engagement surface 55 may be configured to engage with the each of the first heel 32 of the first pawl 28 and the first portion 48 of the first pawl 28. Alternatively, the first angled engagement surface 55 may be configured to engage only one of the first heel 32 of the first pawl 28 and the first portion 48 of the first pawl 28. Moreover, the cam 16 may also include a second angled engagement surface 57. The second angled engagement surface 57 may be configured to engage with each of the second heel 36 of the second pawl 30 and the second portion 54 of the second pawl 30. Alternatively, the second angled engagement surface 57 may be configured to engage only one of the second heel 36 of the second pawl 30 and the second portion 54 of the second pawl 30. Moreover, the first angled engagement surface 55 may be configured to form a first surface angle 59 between the first angled engagement surface 55 and an axis A of the cam 16. Similarly, the second angled engagement surface 57 may be configured to form a second surface angle 61 between the second angled engagement surface 57 and the axis A of the cam 16.

As illustrated in FIG. 1b, the first and second surface angles 59, 61 may be equal to one another such that upon actuation of the cam 16 by the actuator 12, the first and second angled engagement surfaces 55, 57 may simultaneously engage the first and second pawls 28, 30. Alternatively, in some embodiments the first and second surface angles 59, 61 may be different from each other such that upon actuation of the cam 16 by the actuator 12, the first and second angled engagement surfaces 55, 57 may engage the first and second pawls 28, 30 asynchronously. For example, when the first and second angled engagement surfaces 55, 57 are formed having different first and second surface angles 59, 61, a first actuation amount of the cam 16 may cause one of the first and second angled engagement surfaces 55, 57 to engage with one of the first and second pawls 28, 30. Moreover, a second actuation amount of the cam 16 may cause each of the first and second angled engagement surfaces 55, 57 to interact with the first and second pawls 28, 30, respectively. However, when the first and second angled engagement surfaces 55, 57 are formed with different first and second surface angles 59, 61 the first angled engagement surface 55 may engage the first pawl 28 in a different manner than the engagement of the second pawl 30 by the second angled engagement surface 57. It will also be understood that for a given actuation amount of the cam 16, the first and second surface angles 59, 61 may be tailored, or otherwise specified, to produce the desired engagement between the first and second angled engagement surfaces 55, 57 and the first and second pawls 28, 30.

In yet a third non-limiting example, the cam profile 43 of the cam 16 illustrated in FIG. 1c may be alternatively configured with a curved engagement surface 63. The curved engagement surface 63 may be configured to engage with the each of the first heel 32 of the first pawl 28 and the first portion 48 of the first pawl 28. Alternatively, the curved engagement surface 63 may be configured to engage only one of the first heel 32 of the first pawl 28 and the first portion 48 of the first pawl 28. Moreover, in some embodiments, the curved engagement surface 63 may be configured to engage with each of the second heel 36 of the second pawl 30 and the second portion 54 of the second pawl 30. Alternatively, the curved engagement surface 63 may be configured to engage only one of the second heel 36 of the second pawl 30 and the second portion 54 of the second pawl 30. In some embodiments, the curved engagement surface 63 may be configured as a continuous surface such that actuation of the cam 16 may cause the curved engagement surface 63 to simultaneously engage the first and second heels 32, 36 and/or the first and second portions 48, 54 of the first and second pawls 28, 30. Moreover, the curved engagement surface 63 may be formed using a pre-determined radius of curvature that produces the desired engagement between the curved engagement surface 63 with the first and second pawls 28, 30 for a given actuation amount of the cam 16.

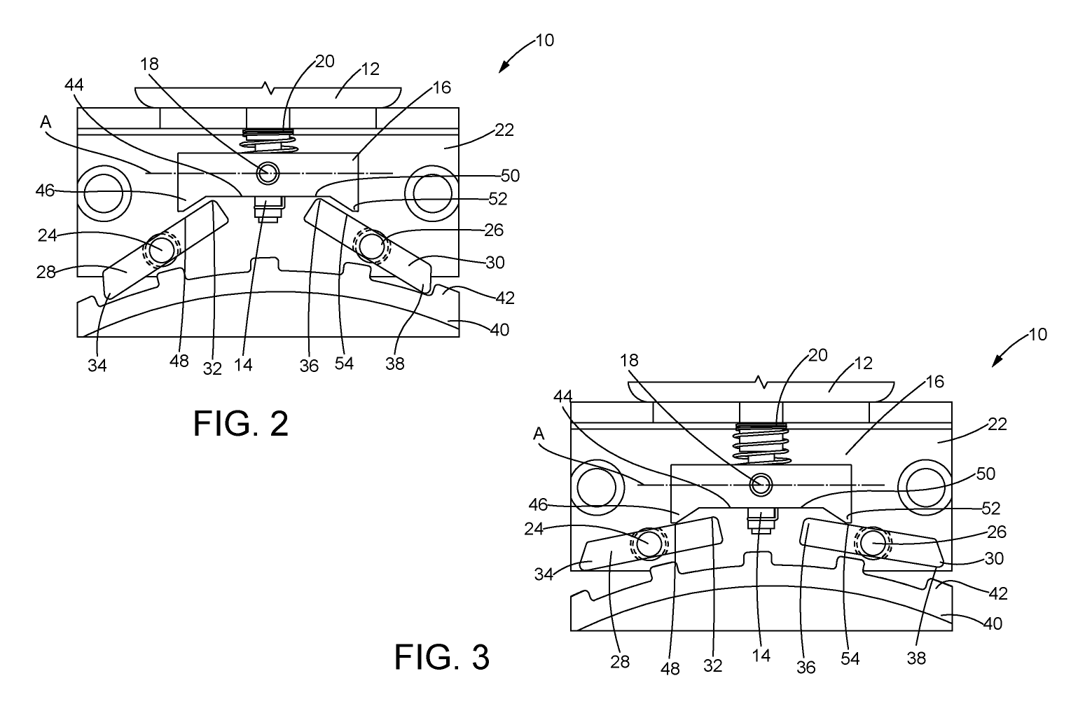

In a first actuator position illustrated in FIGS. 1a-1c, the cam 16 may be disengaged with the first pawl 28 and the second pawl 30. As a result, the first pawl 28 and the second pawl 30 may rotate into the locked/engaged position such that the first and second toes 34, 38 of the first and second pawls 28, 30 interfere with the plurality of notches 42 and the second member 40 is prevented from rotating in a direction. As illustrated in FIG. 2, the actuator 12 may be linearly actuated into a second actuator position such that the first and second engagement surfaces 44, 50 of the cam 16 engages the first heel 32 of the first pawl 28 and the second heel 36 of the second pawl 30, respectively. For example, when the actuator 12 moves from the first actuation positon (FIG. 1a) to the second actuator position (FIG. 2), the armature 14 may cause the cam 16 to move in a linear manner towards the first and second pawls 28, 30, and the second member 40. Such engagement of the cam 16 with the first and second pawls 28, 30, may provide high force such that the first and second pawls 28, 30 rotate, with low lift, out of interference with the notches 42 of the second member 40.

Moreover, as illustrated in FIG. 3, when the actuator 12 is linearly actuated to a third actuator position, the cam 16 may be further linearly actuated towards the first and second pawls 28, 30 and the second member 40. As a result, the first and second protuberances 46, 52 may engage the first portion 48 of the first pawl 28 and the second portion 54 of the second pawl 30, respectively. Contact between the first and second protuberances 46, 52 with the first and second pawls 28, 30 may provide a low force such that the first and second pawls 28, 30 further rotate, with high lift, away and out of interference with the plurality of notches 42 on the second member 40. For simplicity, FIGS. 2 and 3 illustrate only the actuation of the cam 16 having the cam profile 43 illustrated in FIG. 1a. However, it will be understood that actuation the alternative embodiments of the cam 16 provided in FIGS. 1b and 1c may produce similar engagement between the cam 16 and the first and second pawls 28, 30 when the actuator is actuated between the first, second, and third actuator positions. While three such actuator positions are discussed, it will be understood that alternative numbers of actuator positions may be used to achieve the desired actuation of the cam 16.

For example, the cam 16 may be positioned in the second actuator position (FIG. 2) such that the first and second angled engagement surfaces 55, 57 (FIG. 1b), or the curved engagement surface 63 (FIG. 1c), of the cam 16 may engage the first heel 32 of the first pawl 28 and the second heel 36 of the second pawl 30, respectively. Such engagement of the cam 16 with the first and second pawls 28, 30, may similarly provide a high force such that the first and second pawls 28, 30 rotate, with low lift, out of interference with the notches 42 of the second member 40. Moreover, as the actuator 12 moves to the third actuator position (FIG. 3), the cam 16 may move further towards the first and second pawls 28, 30 and the second member 40. Thus, the first and second angled engagement surfaces 55, 57, or the curved engagement surface 63, may engage the first portion 48 of the first pawl 28 and the second portion 54 of the second pawl 30, respectively, to provide a low force such that the first and second pawls 28, 30 further rotate, with high lift, away and out of interference with the notches 42 of the second member 40.

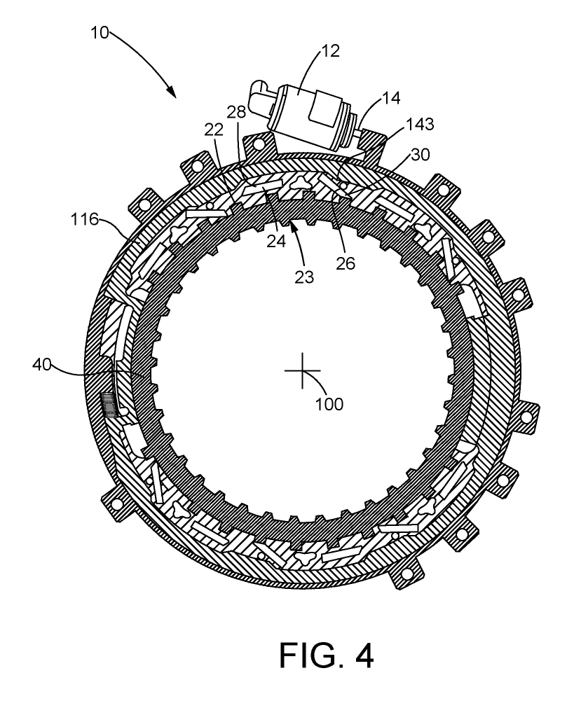

Referring now to FIG. 4, an exemplary selectable clutch module 10 is illustrated. One non-limiting example of the selectable clutch module 10 is illustrated as that of a multi-mode clutch. However it will be understood that the present disclosure may be applied to other types of selectable clutches. The selectable clutch module 10 may include the actuator 12 operably coupled to the armature 14. The actuator 12 may be configured as a solenoid device, magnetic device, a servo motor, a hydraulic device, or other type of actuator. The selectable clutch module 10 may further include the first member 22 that includes the first pawl 28 and the second pawl 30 rotatably coupled to the first member 22 at the first pawl pivot point 24 and the second pawl pivot point 26 respectively. As a result, the first and second pawls 28, 30 may be able to rotate about the first and second pawl pivot points 24, 26. As illustrated in FIG. 4, the selectable clutch 10 may be configured to include a plurality of opposing pairs of the first pawl 28 and the second pawl 30. However, in alternative embodiments, such as illustrated in FIGS. 1a-1c, the selectable clutch module 10 may include a single opposing pair of the first pawl 28 and the second pawl 30. Moreover, the armature 14 may be moved upon actuation by the actuator 12

The selectable clutch module 10 may further include the second member 40 that is configured to rotate relative to the first member 22 and the second member 40 rotates about the clutch axis 100. In some embodiments, the second member 40 may be circular is shape and the second member 40 may be positioned radially interior to the first member 22. Alternatively, the second member 40 may be positioned radially exterior to the first member 22. Furthermore, while an embodiment of the second member 40 having a circular shape is described, is will be understood that alternative shapes and configurations of the second member 40 are possible. Moreover, the second member 40 may include the plurality of notches 42 formed or otherwise arranged on the second member 40, and the plurality of notches 42 may interact with the first pawl 28 and second pawl 30. In one non-limiting example, the plurality of notches 42 may be circumferentially arrayed around the second member 40. However, in some embodiments the plurality of notches 42 may be in an axial arrangement or other such arrangement.

As described above, the first pawl 28 and the second pawl 30 may be incorporated into the selectable locking mechanism 23 such that the first pawl 28 and the second pawl 30 may rotate between an open position and a locked position with respect to the plurality of notches 42. As a result, the selectable clutch module 10 may be capable of selectably operating in a plurality of locking modes. For example, when the first pawl 28 and the second pawl 30 are rotated in the open position, second member 40 of the selectable clutch module 10 may be able to rotate on a particular direction. Moreover, when the first pawl 28 and/or the second pawl 30 are rotated in the locked position, the second member 40 of the selectable clutch module 10 may be prevented from rotating in a particular direction, or both directions.

In one non-limiting example, the selectable clutch module 10 may include a rotatable cam 116 that is implemented for the cam 16 illustrated in FIGS. 1a-1c and 2-3. In some embodiments, the rotatable cam 116 may be circular in shape and the rotatable cam 116 may be positioned in a radially exterior location relative to the second member 40 and the selectable locking mechanism 23, which includes the first pawl 28 and the second pawl 30. Furthermore, the rotatable cam 116 may be operatively associated with the armature 14 such that an actuation of the actuator 12 may cause the armature 14 to impinge on the rotatable cam 116 and rotate the rotatable cam 116 about the clutch axis 100 In some embodiments, the rotatable cam 116 may be configured with a cam profile 143 that is configured to selectively engage with the first pawl 28 and the second pawl 30.

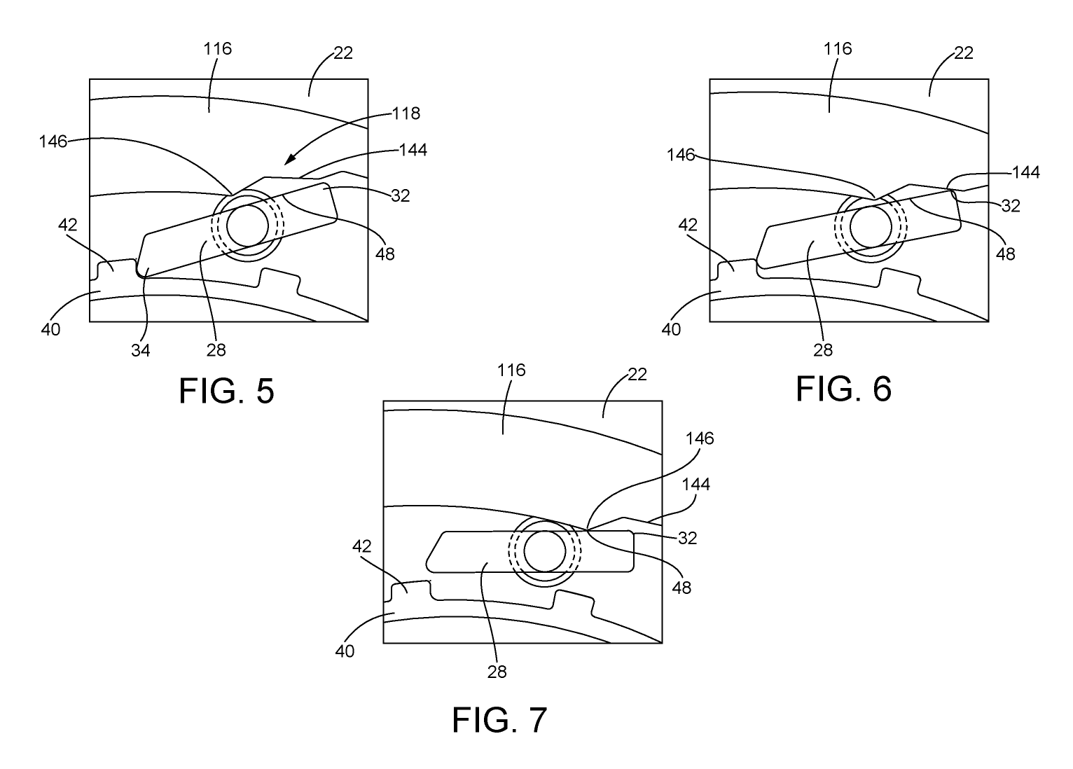

One non-limiting example of the cam profile 143 is illustrated in FIGS. 5-7. As discussed above, the selectable clutch module 10 may implement the rotatable cam 116 in place of cam 16. Furthermore, rotatable cam 116 is illustrated in FIGS. 5-7 with respect to the first pawl 28, but it will be understood that rotatable cam 116 is also configured to interact, or otherwise engage with the second pawl 30 in s similar manner. The second pawl 30 is only omitted from FIGS. 5-7 for the sake of clarity. The rotatable cam 116 may be actuated to move through its rotational range, with respect to the first member 22, to the positions illustrated in FIGS. 5-7. In one non-limiting example, the cam profile 143 of the rotatable cam 116 may include a first engagement surface 144 and a first protuberance 146. The first engagement surface 144 may be configured to engage with the first heel 32 of the first pawl 28 and the first protuberance 146 may be configured to engage with the first portion 48 of the first pawl 28.

As illustrated in FIG. 5, when the first pawl 28 is rotated in the locked/engaged position, the second member 40 may be prevented from rotating due to interference between the first toe 34 of the first pawl 28 and at least one of the plurality of notches 42, and although not shown, interference between the second toe 38 of the second pawl 30 and at least one of the plurality of notches 42. Moreover, as illustrated in FIG. 6, the rotatable cam 116 may be rotated or otherwise actuated, such that the first engagement surface 144 engages the first heel 32 of the first pawl 28, and in a similar manner with respect to the second pawl 30. Such engagement of the rotatable cam 116 with the first pawl 28 may provide high force such that the first pawl 28 rotates, with low lift, out of interference with the notches 42 of the second member 40, and in a similar manner with respect to the second pawl 30. Additionally, as illustrated in FIG. 7 the rotation or actuation of the rotatable cam 116 may further rotate the rotatable cam 116 such that the first protuberance 146 engages the first portion 48 of the first pawl 28. As a result, the engagement between the first protuberance 146 and the first portion 48 of the first pawl 28 may provide low force such that the first pawl 28 is able to further rotate, with high lift, away and out of interference with the plurality of notches 42 of the second member 40.

Furthermore, although not shown it will be understood that the cam profile 143 of the rotatable cam 116 may be may be alternatively configured similar to the cam 16 illustrated in FIGS. 1a-1c and FIGS. 2 and 3. For example, the cam profile 143 may be configured to include the first angled engagement surface 55 and the second angled engagement surface 57 illustrated in FIG. 1b. As a result, the rotatable cam 116 may be rotated, or otherwise actuated, such that the first angled engagement surface 55 engages with the first pawl 28 and the second angled engagement surface 57engages with the second pawl 30. Therefore, the rotatable cam 116 may be able to selectively rotate between a plurality of positions such that the first and second angled engagement surfaces 55, 57 interact with the first and second pawls 28, 30 to produce a plurality of locking modes of the selectable clutch module 10.

Additionally or alternatively, the cam profile 143 may be configured to include the curved engagement surface 63 illustrated in FIG. 1c. As a result, the rotatable cam 116 may be rotated, or otherwise actuated, such that the curved engagement surface 63 engages with the first pawl 28 and the second pawl 30. Therefore, the rotatable cam 116 may be able to selectively rotate between a plurality of positions such that the curved engagement surface 63 interacts with the first and second pawls 28, 30 to produce a plurality of locking modes of the selectable clutch module 10.

It is to be understood that the foregoing is a description of one or more embodiments of the invention. However, the invention is not limited to the particular embodiment(s) disclosed herein. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes and modifications are intended to come within the scope of the appended claims.

### INDUSTRIAL APPLICABILITY

Based on the foregoing, it can be seen that the present disclosure can find applicability in many machines such as, but not limited to automobiles, trucks, vans, agriculture equipment, and construction equipment. Through the novel teachings set forth above, the selectable clutch module may provide dual rates of release on the pawls such that the pawls may be initially released from the second member at a high force and low rise, and then further rotated away from, and out of interference with, the notches of the second member at a low force and high lift.

What is claimed is:

1. A selectable clutch module comprising:
a first member;
a second member positioned adjacent to the first member and the second member being configured to rotate relative to the first member;
a plurality of notches formed on the second member;
an actuator operably coupled to an armature;
a selectable locking mechanism including a first pawl rotatably coupled to the first member about a first pawl pivot point and a second pawl rotatably coupled to the first member about a second pawl pivot point, wherein each of the first and second pawls are configured to interact with the plurality of notches and the first and second pawls are rotatable between an open position and a locked position relative to the plurality of notches such that the selectable locking mechanism is selectively controlled between a plurality of locking modes; and
a cam operatively associated with the armature, the cam including an cam profile configured to engage with the first pawl and the second pawl, wherein the actuator actuates the armature such that the cam profile of the cam is positioned relative to the first pawl and the second pawl to selectably actuate the selectable locking mechanism into one of the plurality of locking modes.

2. The selectable clutch module of claim 1, wherein the cam profile of the cam includes a first engagement surface, a first protuberance, a second engagement surface, and a second protuberance, wherein the first protuberance is located at a first axial end of the cam and the second protuberance is located at a second axial end of the cam, and wherein the actuator actuates the cam into a cam first position associated with a first locking mode of the selectable clutch module such that the first engagement surface interacts with the first pawl to rotate the first pawl into a locked position relative to the plurality of notches and the second engagement surface interacts with the second pawl to rotate the second pawl into a locked position relative to the plurality of notches such that the second member is prevented from rotating due to an interference between the first and second pawls and the plurality of notches.

3. The selectable clutch module of claim 2, wherein the actuator actuates the cam into a second position associated with a second locking mode of the selectable clutch module, and wherein the first engagement surface interacts with the first pawl and the second engagement surface interacts with the second pawl such that each of the first pawl and the second pawl rotate with low lift out of the interference with the plurality of notches.

4. The selectable clutch module of claim 3, wherein the actuator further actuates the cam into a third position associated with a third locking mode of the selectable clutch module, and wherein the first protuberance interacts with the first pawl and the second protuberance interacts with the second pawl such that each of the first pawl and the second pawl further rotate with high lift out of the interference with the plurality of notches.

5. The selectable clutch module of claim 1, wherein the cam profile of the cam includes a first angled engagement surface formed by a first surface angle specified at an intersection of the first angled engagement surface and an axis of the cam, and a second angled engagement surface formed by a second surface angle specified at an intersection of the second angled engagement surface and the axis of the cam, and wherein the actuator actuates the cam into a cam first position associated with a first locking mode of the selectable clutch module such that the first angled engagement surface interacts with the first pawl to rotate the first pawl into a locked position relative to the plurality of notches and the second angled engagement surface interacts with the second pawl to rotate the second pawl into a locked position relative to the plurality of notches such that the second member is prevented from rotating due to an interference between the first and second pawls and the plurality of notches.

6. The selectable clutch module of claim 5, wherein the actuator actuates the cam into a second position associated with a second locking mode of the selectable clutch module, and wherein the first angled engagement surface interacts with the first pawl and the second angled engagement surface interacts with the second pawl such that each of the first pawl and the second pawl rotate with a low lift out of the interference with the plurality of notches.

7. The selectable clutch module of claim 6, wherein the actuator further actuates the cam into a third position associated with a third locking mode of the selectable clutch module, and wherein the first angled engagement surface further interacts with the first pawl and the second angled engagement surface further interacts with the second pawl such that each of the first pawl and the second pawl further rotate with a high lift out of the interference with the plurality of notches.

8. The selectable clutch module of claim 1, wherein the cam profile of the cam includes a curved engagement surface, and wherein the actuator actuates the cam into a cam first position associated with a first locking mode of the selectable clutch module such that the curved engagement surface interacts with each of the first pawl and the second pawl to rotate the first pawl and the second pawl into a locked position relative to the plurality of notches such that the second member is prevented from rotating due to an interference between the first and second pawls and the plurality of notches.

9. The selectable clutch module of claim 8, wherein the actuator actuates the cam into a second position associated with a second locking mode of the selectable clutch module, and wherein the curved engagement surface interacts with the first pawl and the second pawl such that each of the first pawl and the second pawl rotate with a low lift out of the interference with the plurality of notches.

10. The selectable clutch module of claim 9, wherein the actuator further actuates the cam into a third position associated with a third locking mode of the selectable clutch module, and wherein the curved engagement surface further interacts with the first pawl and the second pawl such that each of the first pawl and the second pawl further rotate with a high lift out of the interference with the plurality of notches.

11. A selectable clutch module comprising:
a first member;
a second member configured to rotate about a clutch module axis, the second member positioned adjacent to the first member and the second member being configured to rotate relative to the first member;
a plurality of notches formed on the second member;
an actuator operably coupled to an armature;
a selectable locking mechanism including a first pawl rotatably coupled to the first member about a first pawl pivot point and a second pawl rotatably coupled to the first member about a second pawl pivot point, wherein each of the first and second pawls are configured to interact with the plurality of notches and the first and second pawls are rotatable between an open position and a locked position relative to the plurality of notches such that the selectable locking mechanism is selectively controlled between a plurality of locking modes;
a rotatable cam positioned in a radially exterior position to the second member and the selectable locking mechanism, the rotatable cam operatively associated with the armature such that an actuation of the actuator causes the armature to impinge on the rotatable cam and rotate the rotatable cam about the clutch module axis; and
a cam profile formed on the rotatable cam is configured to selectively engage with the first pawl and the second pawl, wherein the actuation of actuator causes the rotatable cam to rotate such that the cam profile of the rotatable cam is positioned relative to the first pawl and the second pawl to selectably actuate the selectable locking mechanism into one of the plurality of locking modes.

12. The selectable clutch module of claim 11, wherein the cam profile of the rotatable cam includes a first engagement surface, a first protuberance, a second engagement surface, and a second protuberance, wherein the actuator rotates the rotatable cam into a rotatable cam first position associated with a first locking mode of the selectable clutch module such that the first engagement surface interacts with the first pawl to rotate the first pawl into a locked position relative to the plurality of notches and the second engagement surface interacts with the second pawl to rotate the second pawl into a locked position relative to the plurality of notches such that the second member is prevented from rotating due to an interference between the first and second pawls and the plurality of notches.

13. The selectable clutch module of claim 12, wherein the actuator further rotates the rotatable cam into one of a second cam position associated with a second locking mode and a third cam position associated with a third locking mode, wherein when the rotatable cam is rotated into the second cam position the first engagement surface interacts with the first pawl and the second engagement surface interacts with the second pawl such that each of the first pawl and the second pawl rotate with low lift out of the interference with the plurality of notches, and wherein when the rotatable cam is rotated into the third cam position the first protuberance interacts with the first pawl and the second protuberance interacts with the second pawl such that each of the first pawl and the second pawl further rotate with high lift out of the interference with the plurality of notches.

14. The selectable clutch module of claim 11, wherein the cam profile of the rotatable cam includes a first angled engagement surface formed by a first surface angle specified at an intersection of the first angled engagement surface and an axis of the rotatable cam, and a second angled engagement surface formed by a second surface angle specified at an intersection of the second angled engagement surface and the axis of the rotatable cam and wherein the first angled engagement surface and the second angled engagement surface interact with each of the first pawl and the second pawl to rotate the first pawl and the second pawl into a plurality of locked positions that correspond with the plurality of locking modes.

15. The selectable clutch module of claim 11, wherein the cam profile of the rotatable cam includes a curved engagement surface, and wherein the curved engagement surface interacts with each of the first pawl and the second pawl to rotate the first pawl and the second pawl into a plurality of locked positions that correspond with the plurality of locking modes.
